(19) United States
(12) Patent Application Publication
(10) Pub. No.: US 2004/0109083 A1
(43) Pub. Date: Jun. 10, 2004

(54) Digital camera comprising white-balance sensor

(75) Inventor: Atsushi Fuchimukai, Tochigi (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/726,588

(22) Filed: Dec. 4, 2003

(30) Foreign Application Priority Data
Dec. 9, 2002 (JP) P2002-356277

(51) Int. Cl. H04N 5/222

(52) U.S. Cl. 348/371

(57) ABSTRACT

A digital camera has a compact front surface due to a white-balance sensor and an electronic flash device being connected to each other, as one rotatable body. Further, both the light accepting angle and the illuminating angle are automatically adjusted to correspond to an angle of view, by movement of the rotatable body. Therefore, a camera comprising a zooming system is able to adjust the white balance, and emit stroboscope light efficiently.

### BACKGROUND OF THE INVENTION

1. Field of the Invention

The present invention relates to a digital camera comprising white-balance sensor.

2. Description of the Related Art

Conventionally, digital cameras have a plurality of windows on the front surface for a white-balance sensor, an auto-focus mechanism, a viewfinder, and an electric flash device arranged inside the camera body. When light enters the window for the electric flash device from outside, a white-balance sensor measures the color temperature of the light, and the white-balance is adjusted in accordance with the color temperature.

It is difficult to reduce the dimensions of the front surface of a conventional digital camera because of the window that is required for the white-balance sensor. In addition, in the case where a photographing lens is a focal-length adjustable type, such as one composed of zoom lenses, it is impossible to accurately measure the white-balance in accordance with the angle of view, which changes according to the focal length, because the white-balance sensor is fixed in the digital camera body while the focal length of the photographing lens in the lens barrel changes.

### SUMMARY OF THE INVENTION

Therefore, an objective of the present invention is to provide a digital camera that measures white-balance in accordance with an angle of view, and whose front surface has reduced dimensions. To solve the problems mentioned above, according to the present invention, there is provided a digital camera that comprises an electronic flash device that radiates light toward an object to be photographed, a white-balance sensor for performing a white-balance adjustment that is connected with the electronic flash device, and a rotating mechanism. The rotating mechanism rotates the electronic flash device and the white-balance sensor. The electronic flash device and the white-balance sensor form a rotatable body. A digital camera having the rotatable body features to make one of the white-balance sensor and the electronic flash device face an object.

The digital camera also has a lens barrel including photographing lenses whose focal length is adjustable, and the rotatable body is moved in a direction parallel to the optical axis of the photographing lenses, in accordance with their focal length.

The rotatable body is positioned behind a light-emitting lens that is fixed on a front surface of the digital camera.

### BRIEF DESCRIPTION OF THE DRAWINGS.

The present invention will be better understood from the description of the preferred embodiment of the invention set forth below together with the accompanying drawings, in which:

FIG. 1 is a perspective view showing a configuration of the digital camera of the present invention;

FIG. 2 is a perspective view-showing configurations of the photographing optical system, the electronic flash device, the white-balance sensor, the cam plate, and the lens barrel;

FIG. 3 is a sectional view of the electronic flash device and the white-balance sensor;

FIG. 4 is a perspective view of the electronic flash device facing an object to be photographed, and the white-balance sensor;

FIG. 5 is a perspective view of the white-balance sensor facing an object to be photographed, and the electronic flash device;

FIG. 6 is a sectional view showing the rotatable body at the wide-angle end, where the electronic flash device is facing an object to be photographed;

FIG. 7 is a sectional view showing the rotatable body at the wide-angle end, where the white-balance sensor is facing an object to be photographed;

FIG. 8 is a sectional view showing the rotatable body at the tele-photo end, where the electronic flash device is facing an object to be photographed;

FIG. 9 is a sectional view showing the rotatable body the tele-photo end, where the white-balance sensor is facing an object to be photographed;

FIG. 10 is a block diagram of the digital camera;

FIG. 11 is a flowchart explaining a main process of the digital camera;

FIG. 12 is a flowchart explaining a photographing operation of the digital camera.

### DESCRIPTION OF THE PREFERRED EMBODIMENTS

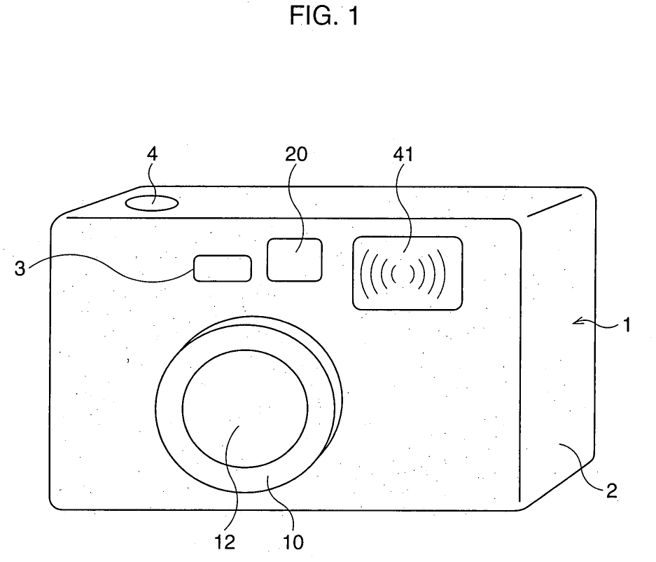

Hereinafter, the preferred embodiment of the present invention is described with reference to the attached drawings. A digital camera 1 of this embodiment, as shown in FIG. 1, comprises an auto-focus window 3, a release switch 4, a zoom-type lens barrel housing a photographing optical system 12 including photographing lenses, a viewfinder window 20, and a Fresnel lens 41 (that is a light-emitting lens). The digital camera 1 has no window for a white-balance sensor, differing from conventional digital cameras.

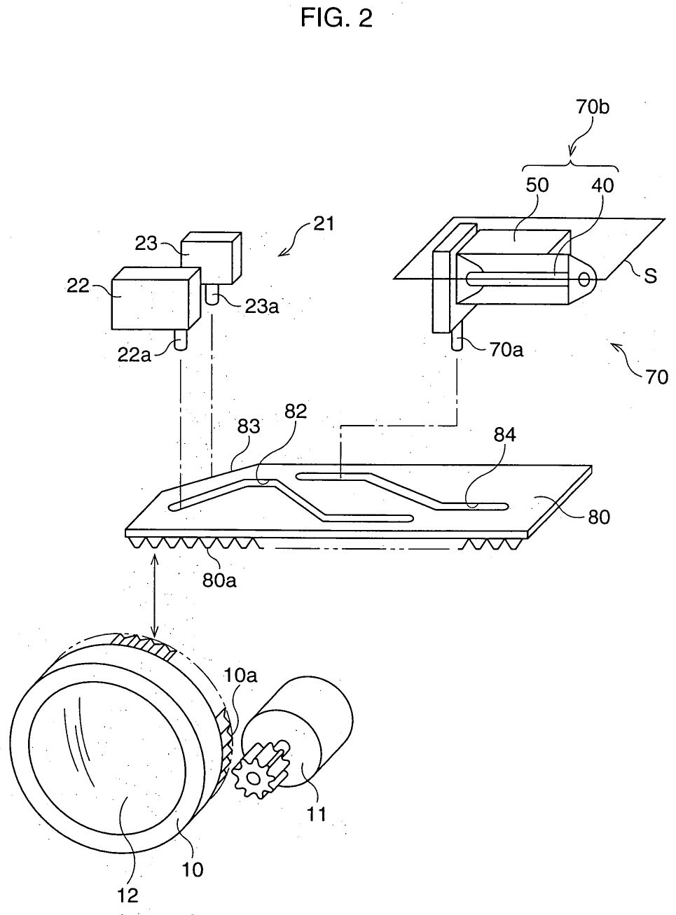

FIG. 2 is a perspective view showing the configuration of the main parts of the digital camera 1. In the camera body 2, as shown in FIG. 2, a viewfinder optical system 21 is set up and located behind the viewfinder window 20. The viewfinder optical system 21 comprises a front lens unit 22 and a back lens unit 23, both having rectangular surfaces corresponding to the photographing area of the digital camera 1.

Behind the Fresnel lens 41, a rotatable body 70 comprising an electronic flash device 40 and a white-balance sensor unit 50 are set up. The electronic flash device 40 and the white-balance sensor unit 50 are connected to each other in one body so that they rotate together. The rotatable body 70 is rotated by a motor (not shown here) to selectively make one of the electronic flash device 40 and the white-balance sensor unit 50 face an object to be photographed through the Fresnel lens 41.

A rectangular cam plate 80 is also provided inside the digital camera 1. The cam plate 80 moves in association with a rotation of the zoom lens barrel 10 for adjusting a focal length, in a direction perpendicular to the optical axis of the photographing optical system 12.

The front lens unit 22 and the back lens unit 23 have cam follower pins 23a and 23b respectively, for engaging with grooves on the cam plate 80. The rotatable body 70 also has a cam follower pin 70a to engage with the cam plate 80.

The zoom lens barrel 10 has a gear section 10a around its circumference, and its axis is the same as that of the photographing optical system 12. The gear section 10a engages with the rack 80a located under the cam plate 80. When the motor 11 rotates the gear section 10a, lenses included in the photographing optical system 12 are moved in the optical axis direction, so that a zooming operation is carried out. The explanation of this zooming mechanism is omitted because it is well known in the prior art.

Since the rotatable body 70, the viewfinder optical system 21, the cam plate 80, and the zoom lens barrel 10 are configured as shown above, when the focal length of the photographing optical system 12 is adjusted by a rotation of the zoom lens barrel 10, the cam plate 80 moves in a perpendicular direction to the optical axis. This movement of the cam plate 80, makes the lens units 22, and 23, and the rotatable body 70, move in a parallel direction to the optical axis, so that they are respectively and automatically put in a suitable position in accordance with the focal length.

Therefore, the cam plate 80 functions as both a zooming system and a moving mechanism that moves the electronic flash device 40 and the white-balance sensor unit 50 which are connected to each other, in accordance with the focal length.

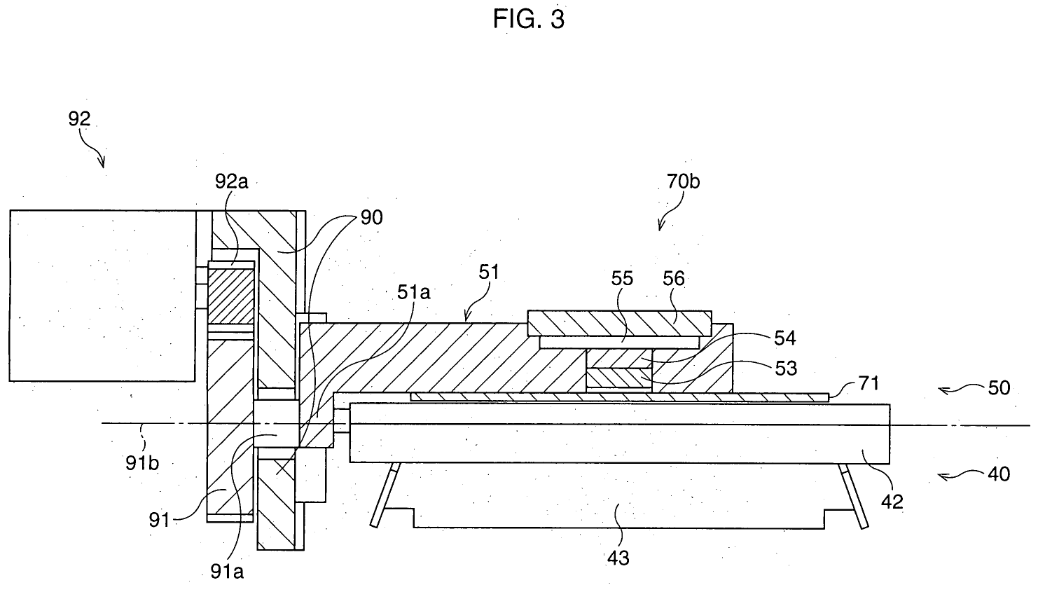

Next, the details of the rotatable body 70 will be explained referring to FIG. 3 to FIG. 5. FIG. 3 is a sectional view taken along plain S of FIG. 2, showing a section of the main parts of the rotatable body 70b.

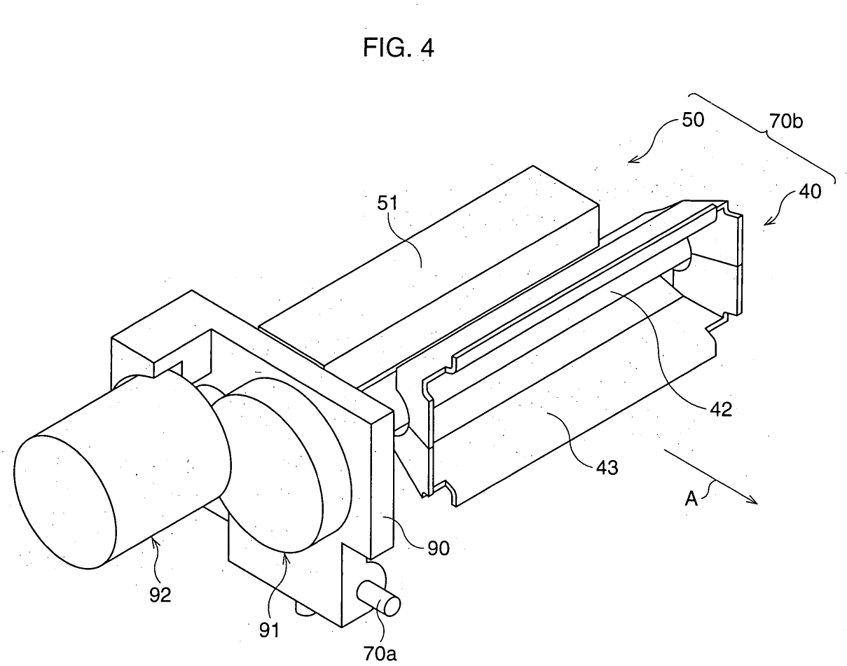

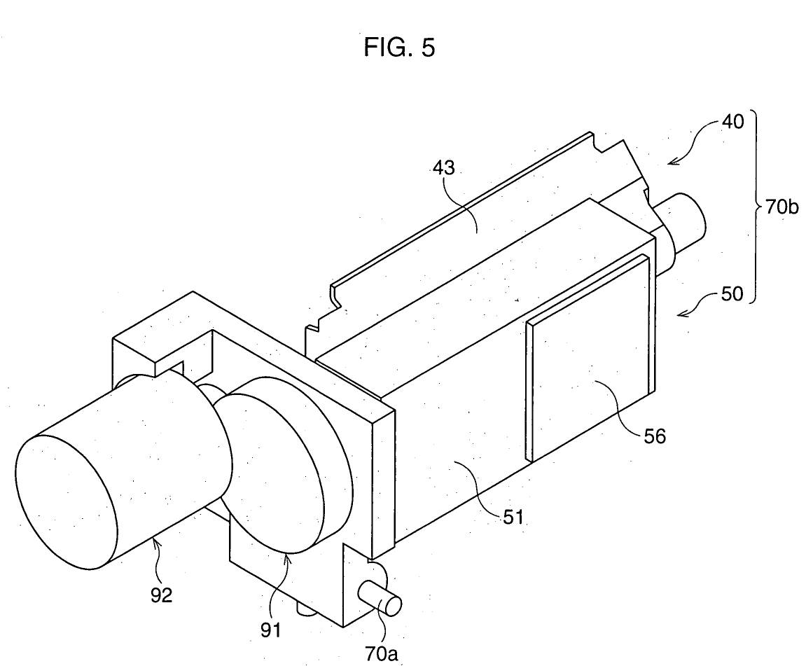

Both FIGS. 4 and FIG. 5 are perspective views of the electronic flash device 40 and the white-balance sensor unit 50. FIG. 4 shows the electronic flash device 40 facing the Fresnel lens (arrow A indicates the direction toward the Fresnel lens). FIG. 5 shows the white-balance sensor unit 50 facing the Fresnel lens 41.

The main parts of the rotatable body 70b are the electronic flash device 40 and the white-balance sensor unit 50, which are connected to each other. The main parts of the rotatable body 70b are arranged so that their longitudinal direction is perpendicular to the optical axis of the photographing optical system 12. This arrangement means that either the electronic flash device 40 or the white-balance sensor unit 50 faces the Fresnel lens 41.

The electronic flash device 40 comprises a xenon tube 42 extending in the longitudinal direction of the Fresnel lens 41, and the reflector 43 covers the xenon tube 42 such that its mouth opens widely as it gets further from the xenon tube 42.

The white-balance sensor unit 50 has a white-balance sensor case 51 having a parallelepiped shape, a white-balance sensor 53 in the case 51, an infrared ray cut glass 54, a gap 55, and a diffusing plate 56 located on the upper surface of the white-balance sensor case 51.

In addition, the white-balance sensor case 51 has a projecting portion 51a which is perpendicular to longitudinal direction of the case 51, and extends in the direction of the electronic flash device 40. The side edge 51a is connected to a gear shaft 91a of the gear 91. A gear axis 91b that is the axis of the gear shaft 91a, extends through the side edge 51a and the xenon tube 42, in the longitudinal direction of the xenon tube 42. The gear 91 is engaged with a gear part 92a of a motor 92. The motor 92 is fixed by a parent plate 90 that is fixed to the digital camera body 2.

Configured in this way, when the gear part 92a rotates, the gear 91 and the gear shaft 91a also rotate, so that the main parts of the rotatable body 70b, that is, the electronic flash device 40 and the white-balance sensor unit 50, also rotates as one body, and the center of the rotation is the gear axis 91b. As a result of the rotation, one of the electronic flash device 40 and the white-balance sensor unit 50 faces the Fresnel lens 41, selectively.

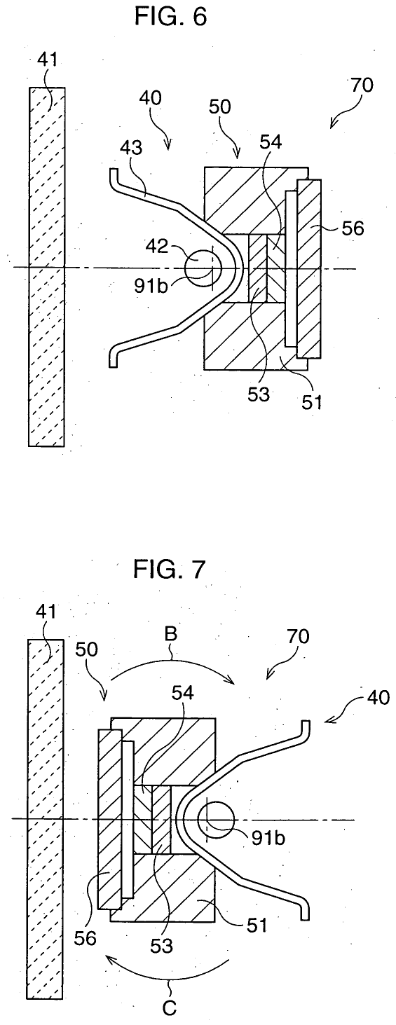

Next, the positional relationships between the electronic flash device 40, the white-balance sensor unit 50, and the Fresnel lens 41 are explained. Both FIG. 6 and FIG. 7 are sectional views of the electronic flash device 40 and the white-balance sensor unit 50 at the wide-angle end. The wide-angle end is the closest point of the rotatable body 70 to an object to be photographed. The electronic flash device 40 faces the Fresnel lens 41 in FIG. 6, on the other hand, the white-balance sensor unit 50 faces the Fresnel lens 41. in FIG. 7.

When the focal length of the photographing optical system 12 is the shortest, the rotatable body 70 is located at the wide-angle end as shown in FIG 6 and FIG. 7. At the time the stroboscope light is emitted, the electronic flash device 40 faces the Fresnel lens 41 as shown in FIG. 6. In the case where the white-balance is going to be continuously measured by the white-balance sensor unit 50 after light emission, the rotatable body 70 is rotated as arrows B and C indicate, and the center of the rotation is the gear axis 91b. The white-balance sensor unit 50 is set to face the Fresnel lens 41 as shown in FIG. 7.

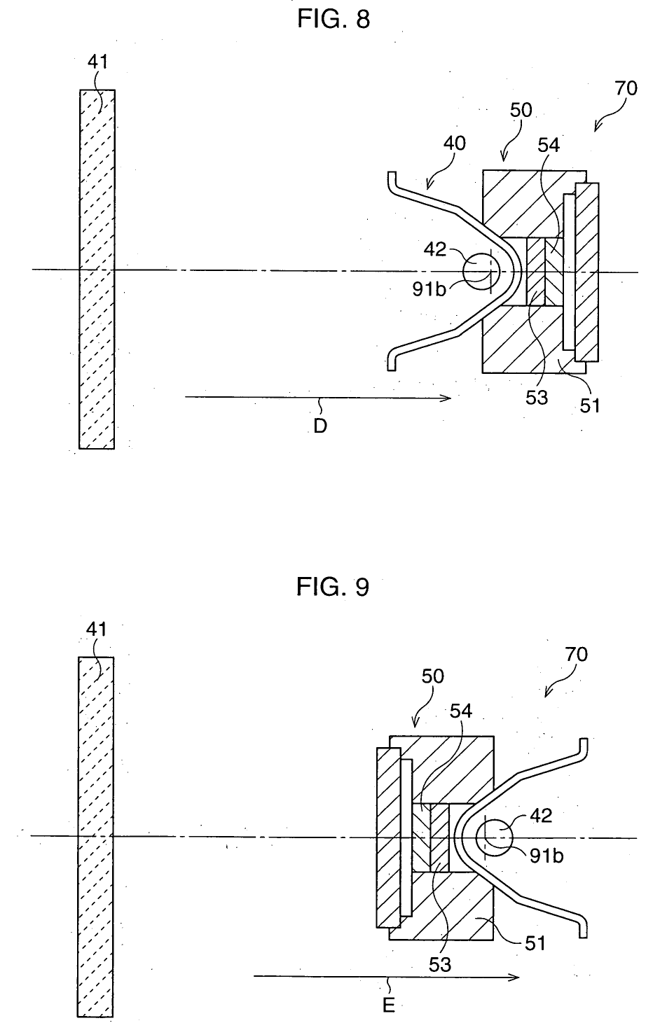

When the focal length of the photographing optical system 12 gets longer, the rotatable body 70 is moved toward the telephoto end, as shown by arrows D and E in FIG. 8 and FIG. 9. The electronic flash device 40 faces the Fresnel lens 41 for emitting stroboscope light as shown in FIG. 8, in a similar way as shown in FIG. 6. In the case where the white-balance is measured after emitting the flash-light, the rotatable body 70 is rotated and then the white-balance sensor unit 50 is set to face the Fresnel lens 41 as shown in FIG. 9, similarly to being at the wide-angle end.

Flash-light is efficiently emitted through the Fresnel lens 41 in accordance with the angle of view because the illuminating angle of the flash-light is reduced as the electronic flash device 40 moves closer to the tele-photo end. The Fresnel lens 41 also functions as a light-accepting lens for measuring chromaticity. The white-balance sensor unit 50 takes a suitable position between the wide-angle end and the tele-photo end for measuring the chromaticity, therefore, the chromaticity-measuring area is also well controlled corresponding to the angle of view of the digital camera 1

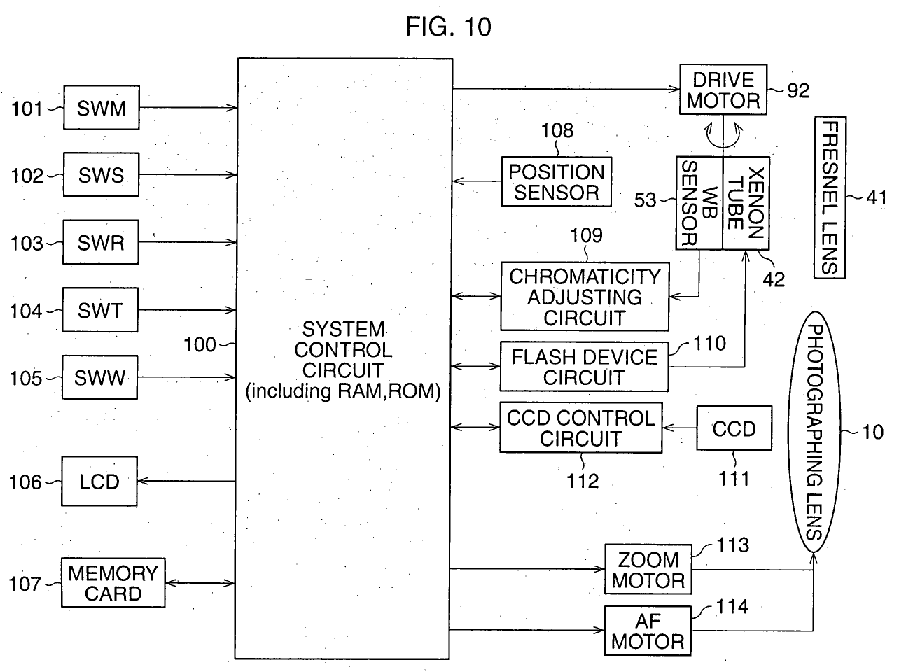

FIG. 10 shows a block diagram of the digital camera 1. Operations carried out in the digital camera 1 are controlled by a system control circuit 100. The system control circuit 100 includes a RAM and a ROM in which reference data, data input by users and so forth are stored.

A main switch (SWM) 101, a chromaticity-measuring switch (SWS) 102, a release switch (SWR) 103, a tele-direction driving switch (SWT) 104, and a wide-direction driving switch (SWW) 105 are connected to the system control circuit 100. When a user operates these switches, predetermined signals are input to the system control circuit 100. The release switch 4 that is a two-step switch whose mechanism is known in the prior art, functions as both the chromaticity-measuring switch (SWS) 102 and the release switch (SWR) 103. When the release switch 4 is partly depressed, the chromaticity-measuring switch (SWS) 102 turns ON, and when the two-step switch is fully depressed, the release switch (SWR) 103 turns ON.

The motor 92, a chromaticity adjusting circuit 109, a flash device circuit 110, a zoom motor 113, and an AF motor 114 are also connected to the system control circuit 100, therefore, each element performs each role as follows under the control of the system control circuit 100.

The motor 92 rotates the rotatable body 70, the chromaticity adjusting circuit 109 controls the color adjustment of the image data, the flash device circuit 110 controls light emission from the xenon tube 42, the zoom motor 113 drives the lens barrel 10, and the AF motor 114 moves the photographing optical system 12 in the lens barrel 10 for focusing.

In addition to these elements, an LCD 106 on a back surface of the digital camera body 2, a memory card 107 in which image data is stored, a position sensor 108 for determining if the digital camera body 2 is positioned vertically or horizontally, and a CCD control circuit 112 for controlling CCD 111, are also connected to the system control circuit 100.

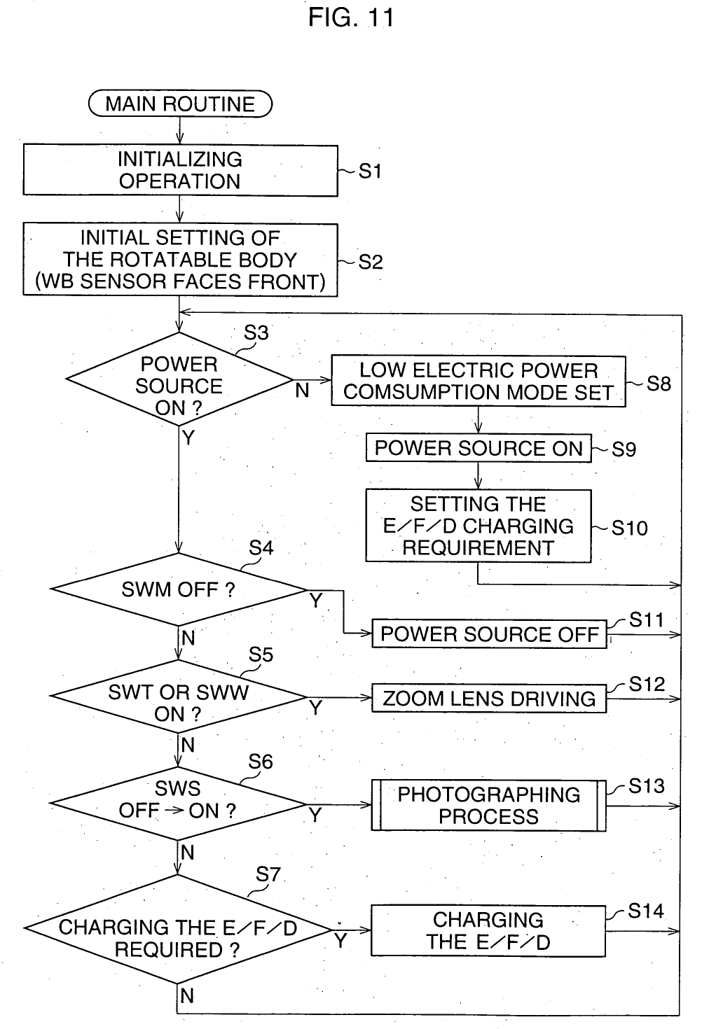

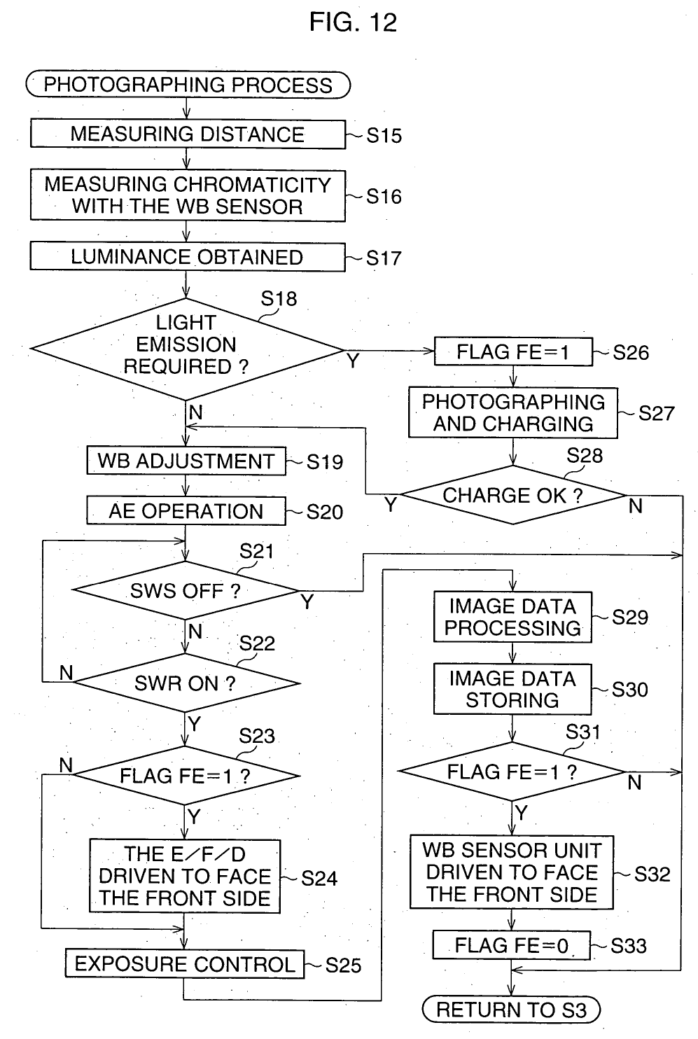

The operations of the digital camera 1 are explained with reference to FIG. 11 showing a main routine, and FIG. 12 showing a photographing process as a sub routine.

At step S1, an initializing operation of the digital camera 1 is carried out. Then, at step S2, the white-balance sensor 50 is set to face the Fresnel lens 41, which is at the initial position. The reason the white-balance sensor 50 faces the Fresnel lens 41 prior to the electronic flash device 40, is that the white-balance should be adjusted before emitting the flash-light. Therefore, in a case where no flash-light is necessary, it is still possible to measure chromaticity and perform the photographing operation in a short time, without performing unnecessary operations such as rotating the rotatable body 70.

At step S3, it is confirmed if the power source is ON, which means whether the digital camera 1 is in an operational state or not. At step S4, it is determined whether the main switch (SWM) 101 is turned OFF or not when the power source is ON. When it is determined that the power source is not ON at step S3, the control proceeds to step S8. At step S8, a low power consumption mode is set, and this mode is maintained while checking the state of the main switch (SWM) 101 until the main switch (SWM) 101 is turned ON. When it is detected that the main switch (SWM) 101 has been turned ON, the low power consumption mode is switched to a regular operation mode by an interrupting operation. At step S9, the power source turns ON. And then, at step S10, a charging requirement of the electronic flash device 40 is set.

When the main switch (SWM) 101 is not OFF (i.e. ON) at step S4, it is detected whether one of the tele-direction driving switch (SWT) 104 and the wide-direction driving switch (SWW) 105 is ON or not at step S5. On the other hand, when the main switch (SWM) 101 is OFF at step S4, the power source is also set to OFF at step S11.

When one of the tele-direction driving switch (SWT) 104 and the wide-direction driving switch (SWW) 105 is ON at step S5, a zooming operation in either direction is carried out at step S12, that is, the photographing optical system 12 in the lens barrel 10 is forced to move in either the tele-direction or the wide-direction depending on which switch is ON, the tele-direction driving switch (SWT) 104 or the wide-direction driving switch (SWW) 105. If both the tele-direction driving switch (SWT) 104 and the wide-direction driving switch (SWW) 105 are OFF at step S5, then whether the chromaticity-measuring switch (SWS) 102 is turned ON or not is detected at step S6.

When the chromaticity-measuring switch (SWS) 102 is ON at step S6, the control proceeds to step S13, in which the photographing process shown in FIG. 12 is carried out. On the other hand, when the chromaticity-measuring switch (SWS) 102 is OFF, at step S7, it is determined if a charge of the electronic flash device 40 has been requested or not.

When a charge of the electronic flash device 40 is required, the electronic flash device 40 is charged at step S14, and when it is not required, the control returns to step S3.

Next, the flow of the photographing process of the digital camera 1 is explained based on FIG. 12.

When the chromaticity-measuring switch (SWS) 102 is detected as ON, the photographing process starts. At step S15, the distance between the digital camera 1 and an object to be photographed is measured with a distance measuring sensor (not shown in any of the figures). Then, the white-balance is adjusted based on the chromaticity measured by the white-balance sensor 53 at step S16. The luminance is obtained at step S17, and then the control proceeds from step S17 to step S18. At step S18, it is determined whether the light emission of the electronic flash device 40 is necessary or not.

When it is determined that light emission is necessary, flag FE is made “1” at step S26. Then after photographing operation and charging of the electronic flash device 40 at step S27, whether the electronic flash device 40 is charged enough or not is determined at step S28.

When the end of the charging is confirmed at step S28, and when light emission of the electronic flash device 40 was not required at step S18, the white-balance is adjusted at step S19. Then, after the AE (Auto Exposure) operation at step S20, the control proceeds to step S21. At step S21, it is determined whether the chromaticity-measuring switch (SWS) 102 is OFF or not. When the switch is OFF, the control returns to step S3 in the main routine ending the photographing process. In addition to the above, when the charging of the electronic flash device 40 is not finished at step S28, the control returns to the main routine.

At step S21, when the chromaticity-measuring switch (SWS) 102 is not OFF (i.e. the chromaticity-measuring switch (SWS) 102 is ON), it is determined whether the release-switch (SWR) 103 is ON or OFF at step S22. The control proceeds to step S23 if the release switch (SWR) 103 is ON, and returns to step S21 if it is OFF. At step S23, it is determined if the flag FE is “1” or not. When the flag FE is “1”, the rotatable body 70 is revolved to make the electronic flash device 40 face the Fresnel lens 41, and then, the exposure is controlled, which means, light is emitted at step S25. On the other hand, if the flag FE is not detected as being “1” at step S23, the control proceeds to step S25 skipping step S24, therefore, the exposure control, at step S25 in this case, does not include light emission.

After the exposure control has ended, image data is processed at step S29 and stored in the system control circuit 100 at step S30. And then, it is determined whether the flag FE is “1” or not at step S31. If the flag FE is not “1”, the control returns to step S3 in the main routine, and if the flag FE is “1”, the rotatable body 70 is rotated and the white-balance sensor unit 50 is faced to the Fresnel lens 41 instead of the electronic flash device 40 at step S32. After the rotation of the rotatable body 70, the flag FE is set to “0” at step S33, the control returns to the main routine, ending the photographing sub routine.

In the preferred embodiment mentioned above, some variations can be provided as follows.

A single focus lens barrel can be used instead of the zoom-type lens barrel 10, and the lens barrel 10 can be a removable type.

The rotatable body 70 can be revolved by a solenoid instead of the motor 92.

The invention is not limited as described in the preferred embodiment, namely, various improvements and changes may be made to the present invention without departing from the spirit and scope thereof.

The present disclosure relates to subject matter contained in Japanese Patent Application No. 2002-356277 (filed on Dec. 9, 2002) which is expressly incorporated herein, by reference, in its entirety.

1. A digital camera comprising;
an electronic flash device that radiates light toward an object to be photographed;
a white-balance sensor for performing a white-balance adjustment, said white-balance sensor and said electronic flash device being connected to each other; and
a rotating mechanism that rotates said white-balance sensor and said electronic flash device to selectively make one of said electronic flash device and said white-balance sensor face said object.

2. A digital camera according to claim 1, wherein said electronic flash device and said white-balance sensor form a rotatable body.

3. A digital camera according to claim 1, further comprising,
a photographing optical system;
a zooming system that adjusts the focal length of said photographing optical system; and
a moving mechanism that moves said white-balance sensor and said electronic flash device in a direction parallel to the optical axis of said photographing optical system, in accordance with said focal length.

4. A digital camera according to claim 3, wherein the shorter said focal length, the closer said white-balance sensor and said electronic flash-device are to said object.

5. A digital camera according to claim 3, further comprising,
a lens barrel that is rotated so that said zooming system adjusts said focal length;
a cam plate that has grooves with which said white-balance sensor, said electronic flash device, and said photographing optical system are engaged, and that moves in a direction perpendicular to said optical axis in association with a rotation of said lens barrel, to function as both said zooming system and said moving mechanism.

6. A digital camera according to claim 1, wherein said white balance sensor is set to face said object when said digital camera is actuated.

7. A digital camera according to claim 1, further comprising a light-emitting lens that is arranged in front of said white-balance sensor and said electronic flash device.
